(19) United States
(12) Patent Application Publication
(10) Pub. No.: US 2003/0202209 A1
(43) Pub. Date: Oct. 30, 2003

(54) System and method for optimizing memory resources in printing devices

(76) Inventors: Douglas J. Mellor, Meridian, ID (US); Charles K. Keyes, Boise, ID (US); Richard M. Dow, Laramie, WY (US); Lisa Johnson, Boise, ID (US); Raymond S. Kennedy, Nampa, ID (US)

Correspondence Address: HEWLETT-PACKARD COMPANY, Intellectual Property Administration, P. O. Box 272400, Fort Collins, CO, 80527-2400, US

(21) Appl. No.: 10/136,923

(22) Filed: Apr. 30, 2002

(51) Int. Cl. G06F 15/00; G06K 1/00; B41F 1/00

(52) U.S. Cl. 358/1.16; 358/1.15

(57) ABSTRACT

A print unit prints pages of a print job in a different page order than the logical page order, but outputs the print job in a logical page order. A control system repetitively selects one or more portions of the print job from a memory device. Each of the one or more portions is selected out-of-logical page order for supply to the print unit to satisfy printing in the different page order. Each of the one or more portions when selected from the memory device, are temporarily stored in location(s) of a print-ready memory until no longer needed for supply to the print unit, at which time the control system releases the location(s) to be able to receive new data. “Memory out” conditions are also avoided by immediately releasing all objects associated with collated printing before completion of the collated print job, if memory is insufficient to complete the job.

### TECHNICAL FIELD

This invention relates to printing devices, and more specifically, systems and methods for optimizing memory resources in printing devices.

### BACKGROUND

Many printing devices, such as those used in connection with computers, have the ability to print double-sided pages, in which printing is automatically performed on both sides of a paper. Usually such printing devices only have a single print unit to perform the two-sided printing. Accordingly, one-side printing is performed by the print unit and the paper is sent to a duplex tray to turn the paper over. Then the paper is fed back to the print unit so the other side can be printed, and the paper is fed to an output bin with two-sided print on the page.

The order in which the front and back sides of a page are printed by the print unit may be out-of-logical page order. That is, instead of printing the front of a certain sheet of paper after the back sheet is printed, some printing devices may print the back of the next sheet while the preceding sheet is held in a duplex tray where it will eventually be inverted so the front-side can be printed. In this example, the back of the next sheet may be printed before the front of the preceding sheet having a lower page number. The print order is handled out-of-logical page order, because printing several backsides and/or front-sides together (or backsides before front-sides) can increase pipelining efficiency of most printing devices used in connection with computers.

However, when a host device sends a two-sided print job request to such a printing device, the page-print requests are usually received in the order sent, in logical page order (from either ascending or descending consecutive order). Once the page data is converted from I/O format (the format in which it is received from the host) to print-ready format (or also called engine-ready format) it is usually stored on a hard disk or RAM disk, or general RAM memory.

Before printing is commenced by the print unit, data associated with the first batch of pages is read from the I/O system into RAM, then converted to print ready format and stored in another location in RAM. Typically, the pages are read in logical page order; therefore, enough pages must be selected from RAM and stored in print-ready memory to ensure that the print unit (which prints out-of-logical order) has enough data to be able to efficiently process the print job request. The amount of storage needed to store the print job is considerable, because several pages at a time may have to be stored in memory before the print engine can begin to print out the print job request.

Take for example a two-sided print job request where a total of six pages out of a larger page print job request are first printed by the printing device. In such a printing device, the duplex queue can hold up to a maximum of three sheets of paper. Also in this example, the printing device initially prints backsides first and then front sides, to increase printing efficiency. The printing device, therefore, will print the backside page first (1B), 2B and 3B and then the first front-side pages (1F), 2F and then 3F. So, a total of six pages read from disk in logical page order must be stored in print-ready memory before a sheet can be output to an output bin. Accordingly, pages need to be loaded into print-ready memory such as RAM before they are printed, which occupies valuable and limited print-ready memory space.

Another problem associated with memory resources, involves collated printing. Sometimes, when collated print job requests are processed, the disk becomes full, making it impossible to complete printing multiple copies associated with the collated print job. Most printers wait until the first original copy of the collated print job is printed prior to declaring the disk full. Usually, the data is retained in memory until the original print job is complete. This is memory intensive, often times causing a “memory out” situation, when the printing device runs out of memory space for all printing requests.

### SUMMARY

The following discussion is directed to systems and methods for optimizing memory resources in printing devices. In one described implementation, a system uses a memory device to store a print job, the print job having a logical page order. A print unit prints pages of the print job in a different page order than the logical page order (in order to improve printer throughput), but outputs the print job in the logical page order. A control system repetitively selects one or more portions of the print job from the memory device. Each of the one or more portions is selected out of logical page order for supply to the print unit to satisfy printing in the different page order. Each of the one or more portions, when selected from the memory device, are temporarily stored in location(s) of memory (in print-ready format) until no longer needed for supply to the print unit, at which time the control system releases the memory location(s) to be able to receive new data.

In another described implementation, a multiple copy collated print job request is received by the printing device. Data associated with printing copies of the multiple copy collated print job are stored in volatile memory and/or on disk. If it is determined that the memory resources of the volatile memory and/or the disk are inadequate to complete the multiple copy collated print job request, then objects associated with printing copies of the multiple collated print job are released without delay.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates various components of an exemplary printing device that can be utilized to implement some of the techniques described herein.

FIG. 2 is a block diagram illustrating components of a memory system for an exemplary printing device.

FIG. 3 shows two different examples of the type of portions of a print job.

FIG. 4 illustrates a method for the memory system used to conserve memory resources when a print unit prints print jobs out-of-logical page order.

FIG. 5 illustrates a method for memory resource conservation in which memory out conditions are avoided by releasing at the earliest possible time, all resources associated with collated copies of a multiple copy collated print job request if it is determined that the memory resources are inadequate.

### DETAILED DESCRIPTION

The following discussion is directed to optimizing memory resources in printing devices. The subject matter is described with specificity to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies.

Overview

The following exemplary implementations introduce the broad concept of reading one or more portions of print-ready data from storage media in print order rather than in logical page order. Once the one or more portions of the data are no longer needed by the print unit, the memory location(s) in which the data is stored can be released, reducing the amount of memory needed for storing print-ready data as compared to conventional systems where print-ready data is traditionally stored in logical page order for consumption by the print unit.

As used herein, a print job generally means a single batch of characters printed as a unit. A print job usually consists of a document; copies of the document; or collated copies of the document; each of which can be one page or multiple pages in length. If not expressly mentioned when the term “print job” is used, it is assumed that the term inherently includes data (in various forms) associated with the print job.

The following exemplary implementations also introduce the broad concept of releasing from memory, objects associated with printing copies of a collated print job as soon as it is determined that memory resources are inadequate to complete the collated print job. The printing device frees-up memory space, by immediately releasing objects appurtenant to collated copies as soon as it is determined that the memory resources are inadequate, rather than waiting for the original copy to be printed, before releasing the objects appurtenant to collated copies.

Exemplary Printing Device Architecture

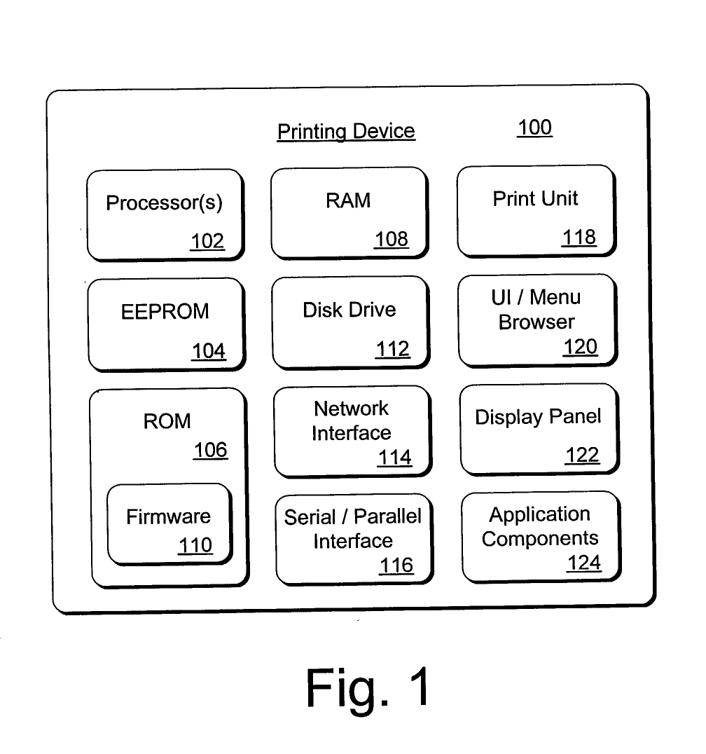

FIG. 1 illustrates various components of an exemplary printing device 100 that can be utilized to implement some of the techniques described herein. Printing device 100 includes one or more processors 102, an electrically erasable programmable read-only memory (EEPROM) 104, ROM 106 (non-erasable), and a random access memory (RAM) 108. Although printing device 100 is illustrated having an EEPROM 104 and ROM 106, a particular printer may only include one of the memory components. Additionally, although not shown, a system bus typically connects the various components within printing device 100.

Printing device 100 includes a firmware component 110 that is implemented as a permanent memory module stored on ROM 106. Firmware 110 is programmed and tested like software, and is distributed with printing device 100. Firmware 110 can be implemented to coordinate operations of the hardware within printing device 100 and contains programming constructs used to perform such operations.

Processor(s) 102 process various instructions to control the operation of the printing device 100 and to communicate with other electronic and computing devices. The memory components, EEPROM 104, ROM 106, and RAM 108, store various information and/or data such as configuration information, fonts, templates, data being printed, and menu structure information. Although not shown, a particular printer can also include a flash memory device in place of or in addition to EEPROM 104 and ROM 106.

Printing device 100 also includes a disk drive 112, a network interface 114, and a serial/parallel interface 116. Disk drive 112 provides additional storage for data being printed or other information maintained by printing device 100. Although printing device 100 is illustrated having both RAM 108 and a disk drive 112, a particular printer may include either RAM 108 or disk drive 112, depending on the storage needs of the printer. For example, an inexpensive printer may include a small amount of RAM 108 and no disk drive 112, thereby reducing the manufacturing cost of the printer.

Network interface 114 provides a connection between printing device 100 and a data communication network. Network interface 114 allows devices coupled to a common data communication network to send print jobs, menu data, and other information to printing device 100 via the network. Similarly, serial/parallel interface 116 provides a data communication path directly between printing device 100 and another electronic or computing device. Although printing device 100 is illustrated having a network interface 114 and serial/parallel interface 116, a particular printer may only include one interface component.

Printing device 100 also includes a print unit 118 that includes mechanisms arranged to selectively apply an imaging medium such as liquid ink, toner, and the like to a print media in accordance with print data corresponding to a print job. Print media can include any form of media used for printing such as paper, plastic, fabric, Mylar, transparencies, and the like, and different sizes and types such as 8½×11, A4, roll feed media, etc. For example, print unit 118 can include an inkjet printing mechanism that selectively causes ink to be applied to a print media in a controlled fashion. The ink on the print media can then be more permanently fixed to the print media, for example, by selectively applying conductive or radiant thermal energy to the ink.

Print unit 118 can also include a duplex tray, used to hold printed pages associated with double-side pages, until the opposite side of a page is ready to be printed. Those skilled in the art will recognize that there are many different types of print units available, and that for the purposes of the present invention, print unit 118 can include any of these different types.

Printing device 100 also includes a user interface and menu browser 120, and a display panel 122. The user interface and menu browser 120 allows a user of the printing device 100 to navigate the printer's menu structure. User interface 120 can be indicators or a series of buttons, switches, or other selectable controls that are manipulated by a user of the printer. Display panel 122 is a graphical display that provides information regarding the status of printing device 100 and the current options available to a user through the menu structure.

Printing device 100 can, and typically does include application components 124 that provide a runtime environment in which software applications or applets can run or execute. Those skilled in the art will recognize that there are many different types of runtime environments available. A runtime environment facilitates the extensibility of printing device 100 by allowing various interfaces to be defined that, in turn, allow the application components 124 to interact with the printer.

General reference is made herein to one or more printing devices or other image forming devices, such as printing device 100. As used herein, “printing device” means any electronic device having data communications, data storage capabilities, and/or functions to render printed characters and images on a print media. A printing device may be a printer, fax machine, copier, plotter, and the like. The term “printer” includes any type of printing device using a transferred imaging medium, such as ejected ink, to create an image on a print media. Examples of such a printer can include, but are not limited to, inkjet printers, plotters, portable printing devices, as well as multifunction combination devices (MFP). Although specific examples may refer to one or more of these printers, such examples are not meant to limit the scope of the claims or the description, but are meant to provide a specific understanding of the described implementations.

Memory System

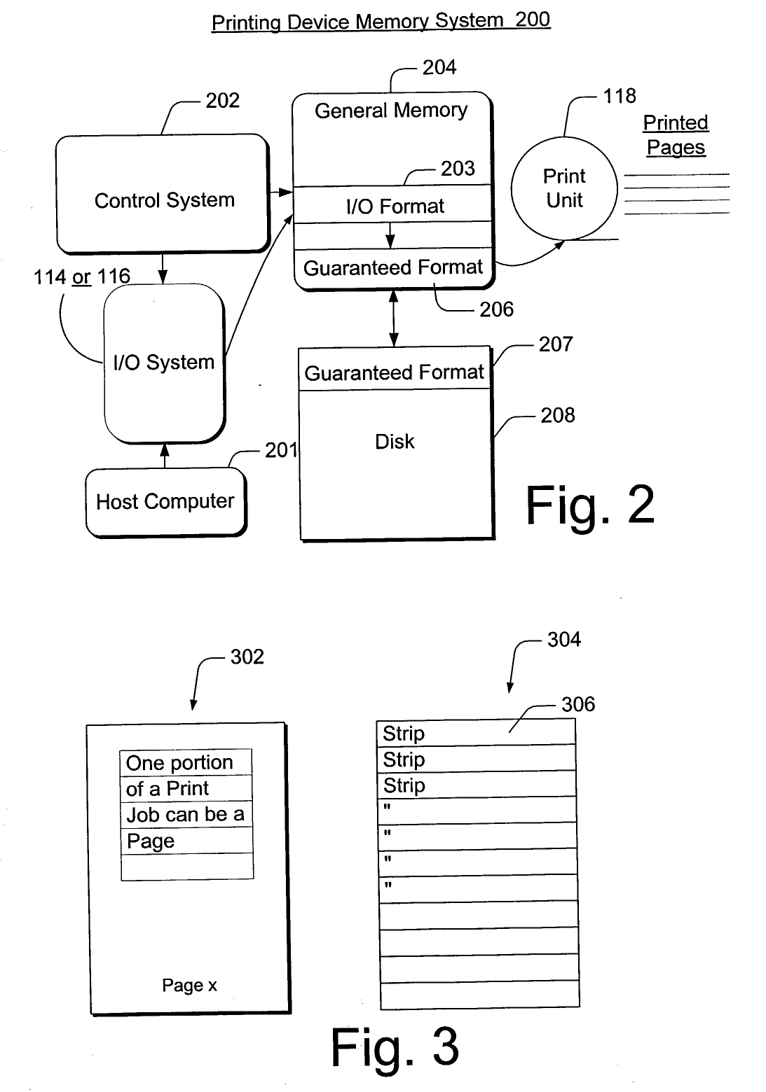

FIG. 2 is a block diagram illustrating components of a memory system 200 for printing device 100. Memory system 200 can include, or be implemented with, one or more of the following components: an I/O system (e.g., 114 or 116), a control system 202, a general memory 204, a disk 208 and print unit 118, which are one or more of the components from the exemplary printing device 100 (FIG. 1). Each of these components will now be described in more detail.

A host computer 201 is interfaced with memory system 200 via I/O system, which can be implemented as a network interface 114 or serial/parallel port 116 as described above with reference to FIG. 1. Typically, an exemplary host computer 201 sends print jobs to printing device 100 in page description format also referred to herein as I/O format. Before being sent to print unit 118 for printing, data associated with a print job is normally converted to print-ready format. Accordingly, the print job is temporarily stored in a buffer region 203 of general memory 204 after being received from host 201. The print job is then converted to a print-ready format (guaranteed format) and stored in another location 206 of memory 204. At this point, the one or more portions of the print job can be sent directly to print unit 118 for printing.

General memory 204 is typically implemented through the use of a volatile memory device such as RAM 108 (shown in FIG. 1), which is described above with respect to the exemplary printing device 100 (FIG. 1).

In the event the print job is of a type that requires multiple copies or other permanency, (e.g., certain collated print job requests or multiple copy two-sided print job requests), then print-ready data associated with such a print job will normally be stored in an area such as a RAM disk or on a separate medium such as a disk drive. Disk 208 represents either of such non-volatile memory areas. Whereas, disk 208 can be a RAM disk or hard disk (such as disk drive 112).

Control system 202 controls the flow of data in memory system 200. Control system 202 is implemented as a combination of either firmware (in the form of instructions or logic) 110 (FIG. 1) and/or software (in the form of instructions or logic) (where firmware and/or software is collectively referred to as i.e., “computer executable instructions”) running on processor 102 (FIG. 1). The computer executable instructions can be stored on some type of computer-readable media, such as ROM, flash, floppy disk, etc. Each of these components is described above with respect to the exemplary printing device 100 (FIG. 1). In other implementations, it is possible to use other processor based systems such as application specific integrated circuits (ASICs), programmable state-machines or other microprocessor based control systems.

In order to improve throughput, print unit 118 may print pages out-of-logical page order. Assuming the print job is stored on disk 208 such as location 207, control system 202 selects one or more portions of a print job in the same out-of-logical page order as the print unit 118 prints. These portions are then stored in memory location(s) 206 (location 206 represents one or multiple locations) within general memory 204. These one or more portions can then be sent directly from print-ready memory 204 to print unit 118. The control system 202 selects one or more portions of the print from disk 208 out-of-logical page order for supply to the print unit 118 to match the print unit's 118 page printing order for completing the print job (such as when printing two-sided pages in a multiple page print job). If print unit 118 no longer needs the one or more portions from locations 206, then control system 202 releases the locations 206 in memory 204.

By storing print-ready data in memory 204 according to its printing order, as opposed to logical page order, memory system 200 consumes less memory in printing device 100 than conventional systems. Typically, only the print-ready data needed for printing is stored in locations 206 of memory 204 at any one time, as opposed to traditional systems where data is stored in logical-page order wasting memory space. Additionally, by freeing-up locations 206 in print-ready memory 204 as soon as the data stored in these locations is no longer needed, ensures that the print-ready memory 204 is used efficiently.

As used herein, “no longer needed” means (i) that the print unit 118 has received the data and is able to initiate printing an image based on receipt of the data and/or (ii) that the print unit 118 has successfully output a printed page that includes all the data and it is safe to clear the data from print-ready memory 204. The latter ensures that if there is a paper jam (or other malfunction), the printing device 100 is able to reestablish printing by re-reading data from memory 204 that may have already been received by the print unit 118, prior to the malfunction.

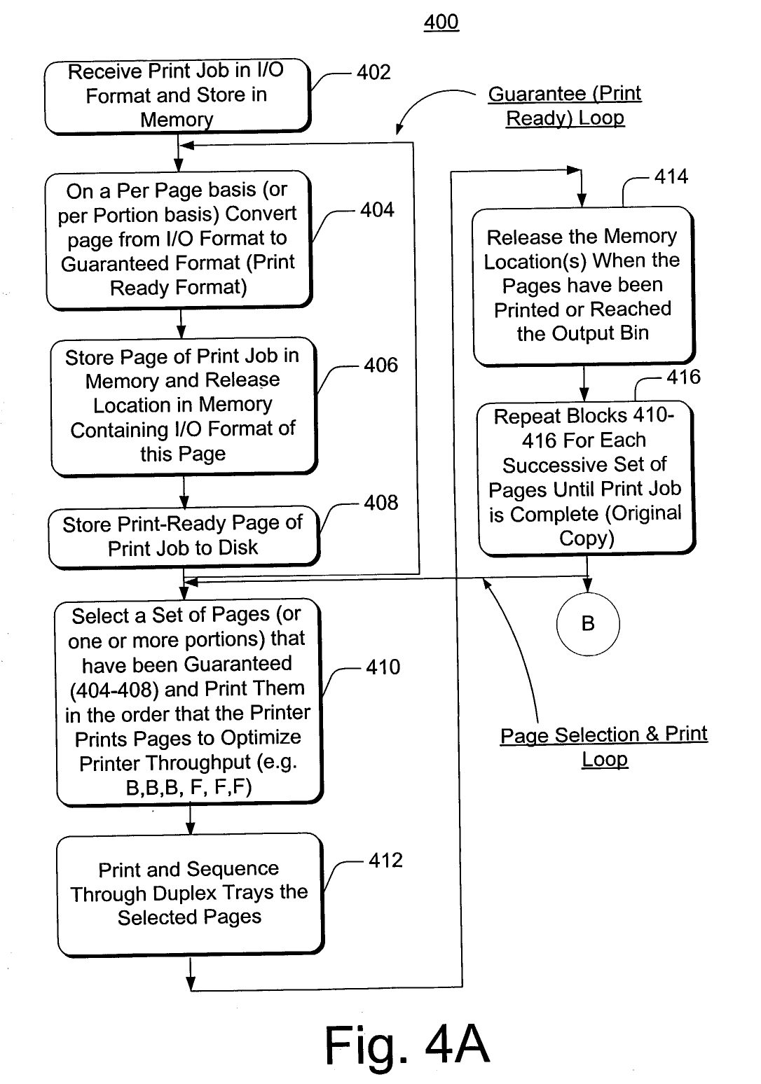

FIG. 3 shows two different examples of the type of portions of a print job that can be selected from disk 208. As used herein one or more portions can be the entire print job, a page of a print job, or another smaller or larger combination of some portion of an entire print job. Example 302 represents one exemplary portion of a print job. The portion in example 302 is a page of print job 206.

FIG. 3 shows that one or more portions of a print job can also consist of strips 306. In one implementation, a page can consist of approximately forty (40) strips 306. Thus, the aforementioned illustration shows that a portion of a print job can be multiple portions such as pages or strips, or may be the entire print job. Note: A strip is subset of a page: being a horizontal or vertical slice of the page (see below). As shall become apparent to those skilled in the art, selecting portions of a print job out-of-logical print order, rather in print order provides the benefit of freeing-up memory space at the completion of printing a portion of a print job rather than having to wait for the print job to complete printing all the portions waiting in memory in order, but printed out-of order, before freeing-up memory space.

Methods for Memory System

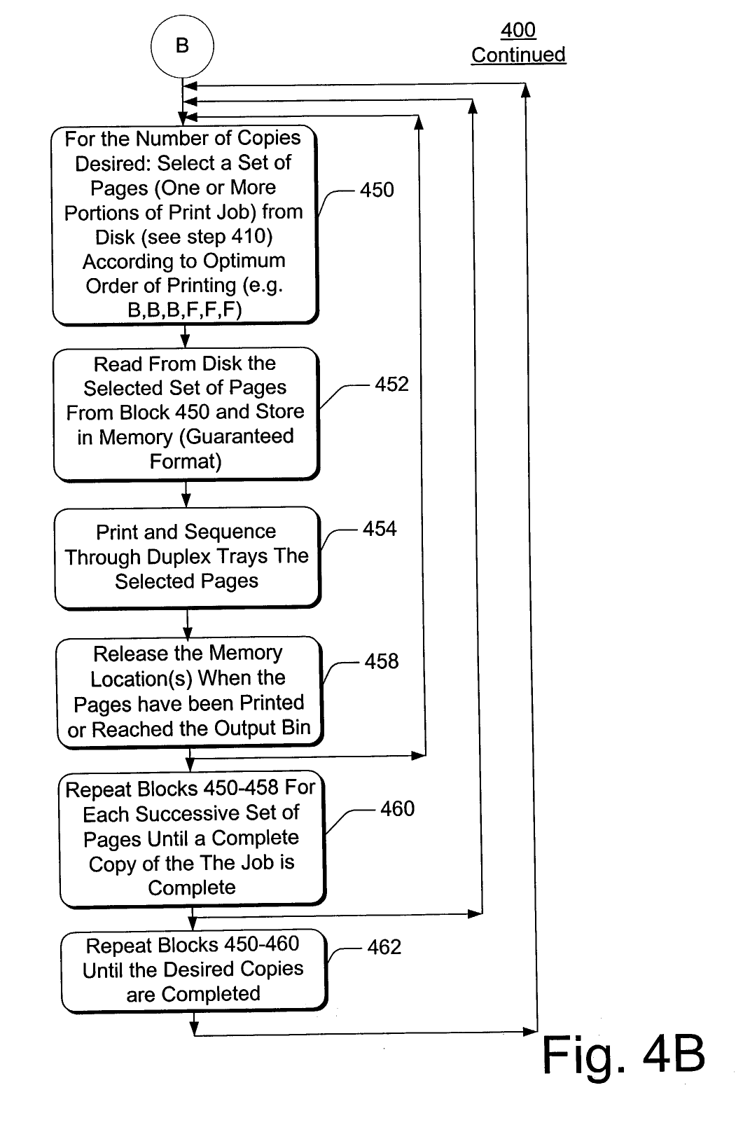

FIG. 4 illustrates a method 400 for a memory resource conservation system 200. This illustration shows how a print job (such as double-sided print jobs) that is printed out-of logical page order by the print unit 118 is stored and maintained in memory. Method 400 conserves memory resources, because data is selected in the same order as needed by the print unit 118, rather than in logical page order, which can use up to two times the amount of volatile memory space. Data is stored on-demand of the print unit 118 and to match the order of printing performed by the print unit 118. Data is cleared from locations 206 as soon as it is no longer needed.

Method 400 includes various operations illustrated as blocks. The order in which the process is described is not intended to be construed as a limitation. Furthermore, the process can be implemented in any suitable hardware, software, firmware, or combination thereof. In the exemplary implementation, the majority of operations are performed in firmware running on processor(s) 102.

At a block 402, printing system 100 receives a print job in I/O format. The I/O format is the format in which a host sends print jobs to its respective printing device, for instance a page description format. In most instances, the I/O format is received in a logical page order in ascending or descending page order. This includes print job requests involving double-sided pages. At this point, the print job is stored in a location 203 in memory 204 until it can be converted to print-ready format.

At a block 404, control system 202 converts from I/O format to a guaranteed format. This is performed on a per-page basis (or other portion of the print job such as strips) That is, control system 202 rasterizes and compresses pages of the print job and converts the print job from I/O format to a print-ready format ready for printing by the print unit 118.

At a block 406, control system 202 stores the print job in a location(s) 206 of memory 204 and releases corresponding locations 203 containing the I/O format of the converted page. Then at a block 408, assuming the print job is collated print job or multiple copy two-sided printed job, etc., the print-ready page is also stored in a location 207 of disk.

Blocks 404 through 408 repeat for each successive page until all successive pages have been converted and stored accordingly. Blocks 410 through 416 shall now be described. Blocks 410-416 describe the printing of the pages converted in blocks 404-408. Operations performed in blocks 410-416 are performed in parallel with operations performed in blocks 404-408; however operations performed in blocks 410-416 can only be performed on pages that have previously completed blocks 404 to 408.

At a block 410, control system 202 selects a set of pages from locations 206 in memory 204 (previously converted in blocks 404-408) according to the order that the print unit 118 prints the pages to optimize printer throughput. For example, if three backside pages (B, B, B) are printed before three front-side pages (F, F, F), then the pages will be selected in that order.

At a block 412, the selected pages are printed by the print unit 118 and sequenced through a duplex tray (not shown). At a block 414, the memory locations 206 where the selected pages are stored are released from memory 204. That is, the memory locations 206 in which the pages reside can be erased and/or overwritten with new data. The pages are released when no longer needed, as mentioned above, when they have been successfully printed and sent to the output bin or when they have been printed, but prior to necessarily reaching the output bin.

At a block 416, blocks 410-416 are repeated for each successive set of pages until the print job is complete for the first original copy of the print job request. Now method 400 proceeds to FIG. 4B which describes the memory operations for each copy of the print job. If not expressly mentioned, most of the operations performed in method 400 are controlled through control system 202.

Referring to FIG. 4B, at a block 450, for each copy of the print job, a set of pages (again this could be one or more portions of a print job) are read from disk as described in block 410.

At a block 452 these selected pages from block 450 are stored in locations 203 of memory 204. At a block 454 these pages are printed by the print unit 118 and sequenced through the duplex tray (not shown).

At a block 458, the locations 206 in memory 204 when the printed pages are printed or reach the output bin (as described with reference to block 414) (i.e., no longer needed), are released from memory 204.

At a block 460, blocks 450-458 are repeated until all successive pages are printed and a complete copy of the print job is printed. Now, at a block 462, blocks 450-460 are repeated until each successive copy is complete.

As a result of method 400, memory efficiencies are realized. For example, suppose that a two-sided print job request is received by printing device 100. The printing device contains a duplex tray that has a capacity of three sheets. Suppose the print unit 118 receives three backside pages worth of data first and prints them. Now, the duplex tray is full and in order to send a sheet from the tray to the output bin, the print unit 118 receives a front-side page of data; prints the front side corresponding to one of the backside pages; and outputs the page to an output bin. Assuming that method 400 is used to implement support for printing in accordance with this example, a maximum of four pages worth of data needs to be stored in memory 204 at any one time (assuming that the printing device is operating in a print jam mode where memory 204 is not released until pages are output to a user). On the other hand, in a traditional printing device using the same example, a minimum of six pages is needed to be stored at any one time 1F, 1B, 2F, 2B, 3F, 3B, because data is selected from disk in logical page order as opposed to out-of-logical page order.

Avoiding Memory Out Conditions

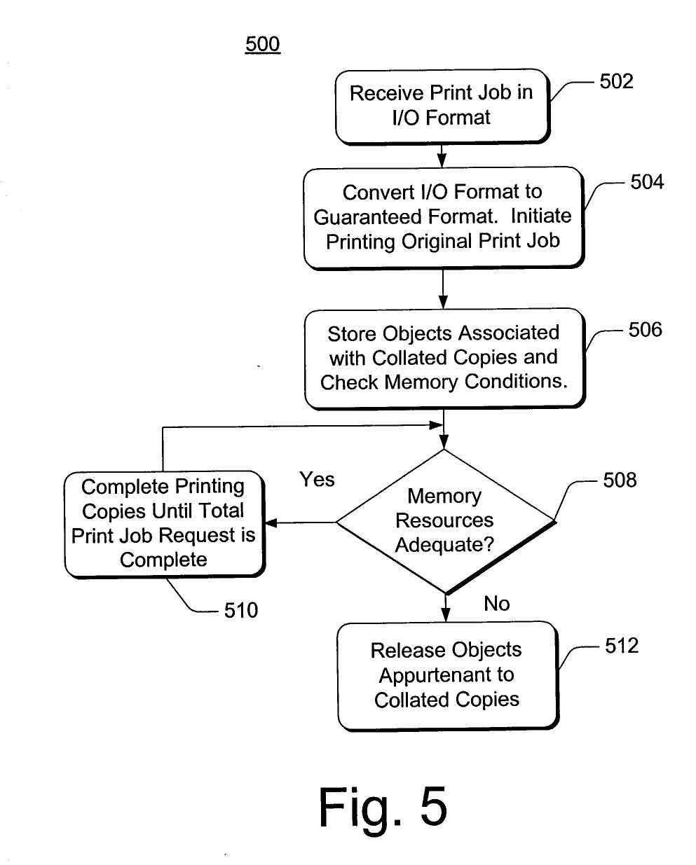

FIG. 5 illustrates a method 500 for avoiding memory out conditions for a memory system 200. This illustration shows how memory out conditions are avoided by releasing at the earliest possible time, all resources associated with collated copies of a multiple copy collated print job request. Method 500 includes various operations illustrated as blocks. The order in which the process is described is not intended to be construed as a limitation. Furthermore, the process can be implemented in any suitable hardware, software, firmware, or combination thereof. In the exemplary implementation, the majority of operations are performed in firmware running on processor(s) 102.

At a block 502, printing system 100 receives a print job in I/O format. The I/O format is the format in which a host sends print jobs to its respective printing device, for instance a page description format. If the print job request is in the form of a multiple copy collate print job request, the method 500 is particularly well suited.

At a block 504, control system 202 converts the data from I/O format to a guaranteed format. That is, control system 202 rasterizes and compresses the print job and converts the print job from I/O format to a print ready format ready for printing by the print unit 118. It is at this time, that data and associated buffers and objects associated with multiple copies of the original are written to disk 208. At this point, disks, and RAM disks in particular, are susceptible of running out of space to store all the information.

Accordingly, at a block 506 the control system 202 checks how much memory resources are available for storing all the objects associated with collated copies. In the mean-time the print job continues and the I/O conversion process proceeds in parallel.

At a block 508, control system 508 determines whether the memory resources are adequate for the pages processed up to this point (control system 508 is not able to predict what's being sent by a host). If they are adequate, then according to block 510 the print job request is processed until all collated copies are printed. On the other hand, if the memory resources are inadequate, then at a block 512, control system 202 immediately releases all objects appurtenant to collated copies, rather than waiting until the original copy is complete. Accordingly, all objects (files, data, buffers, etc. on disk 208 and/or in memory 204) are released, at the earliest possible detection that memory resources are inadequate. This accelerates the time that these resources are released and minimizes the chances that a “memory out” condition (no more memory) is reached, precluding even a first copy from being printed.

### CONCLUSION

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A system, comprising:
a memory device configured to store a print job, the print job having a logical page order;
a print unit configured to print pages of the print job in a different page order than the logical page order, but outputs the print job in the logical page order; and
a control system configured to repetitively select one or more portions of the print job from the memory device, each of the one or more portions selected out of logical page order for supply to the print unit to satisfy printing in the different page order, wherein each of the one or more portions when selected from the memory device, are temporarily stored in location(s) of a general memory until no longer needed for supply to the print unit, at which time the control system releases the location(s) to be able to receive new data.

2. The system as recited in claim 1, wherein the print job is stored in the memory device in engine ready format.

3. The system as recited in claim 1, wherein each of the one or more portions is a page of the print job.

4. The system as recited in claim 1, wherein each of the one or more portions is a strip of a page of the print job.

5. The system as recited in claim 1, wherein the control system releases the location(s) after the print unit receives each of the one or more portions and successfully outputs a printed page that includes each of the one or more portions of the print job.

6. The system as recited in claim 1, wherein the control system releases the location(s) after the print unit receives one or more portions, but prior to each of the one or more portions being output on a printed page.

7. The system as recited in claim 1, wherein the print job contains a plurality of two-sided pages.

8. In a printing device that prints pages out-of-logical page order within the printing device, but outputs the pages to an output bin in a logical page order, a method, comprising:
selecting a portion of data from a memory device to match the out-of-logical page order of the printing device, the data associated with a print job request;
storing the portion of the data in a memory location of a print-ready memory; and
releasing the memory location when the print-ready data is no longer needed for printing.

9. The method as recited in claim 8, further comprising:
selecting a next portion of the data from the memory device to match the out-of-logical page order of the printing device;
storing the portion of the data in a memory location of the print-ready memory; and
releasing the memory location when the next portion of the data is no longer needed for printing.

10. The method as recited in claim 8, wherein each portion of the data is a page of a multiple page document.

11. The method as recited in claim 8, wherein each portion of the data is a strip of a page of a multiple page document.

12. The method as recited in claim 8, wherein releasing the memory location when the data is no longer needed for printing, occurs after the portion of the data is output from the printing device on a printed page.

13. The method as recited in claim 8, wherein releasing the memory location when the data is no longer needed for printing, occurs after the portion of the data is received for printing by a print unit.

14. The method as recited in claim 8, wherein the pages are part of one or more two-sided pages of a multiple page document.

15. One or more computer-readable media having stored thereon computer executable instructions that, when executed by one or more processors, causes the one or more processors of a printing device to:
print pages out-of-logical page order;
store print-ready data in a memory device;
select a portion of the print-ready data from the memory device to match the out-of-logical page order used to print pages;
store the portion of the print-ready data in a memory location of a print-ready memory; and
release the memory location, when the portion of the print ready data is no longer needed for printing.

16. One or more computer-readable media as recited in claim 15, further comprising computer executable instructions that, when executed, direct the printing device to:
select a next portion of the print-ready data from the memory device to match the out-of-logical page order;
store the portion of the print-ready data in a memory location of the print-ready memory; and
release the memory location in which the next portion of the print-ready data is stored, when the next portion of the print ready data is no longer needed for printing.

17. One or more computer-readable media as recited in claim 15, wherein each portion of the print-ready data is a page of a multiple page document.

18. One or more computer-readable media as recited in claim 15, wherein each portion of the print-ready data is a strip of a page of a multiple page document.

19. One or more computer-readable media as recited in claim 15, further comprising computer executable instructions that, when executed, direct the printing device to: release the memory location when the print ready data is output from the printing device on a printed page.

20. One or more computer-readable media as recited in claim 15, further comprising computer executable instructions that, when executed, direct the printing device to: release the memory location when the print ready data is received for printing by a print unit.

21. One or more computer-readable media as recited in claim 15, wherein the pages are part of one or more two-sided pages of a multiple page document.

22. In a printing device for printing two-sided pages of print job out-of-logical print order, but outputs the print job in logical print order, a method, comprising:
(a) receiving a two-sided, multiple page print job request;
(b) storing, in print-ready memory, a certain number of backside page(s) of the two-sided multiple page print job request; the certain number of backside pages corresponding to the out-of-logical print order;
(c) printing the certain number of backside page(s);
(d) releasing the certain number of backside page(s) from print-ready memory when no longer needed for printing;
(d) storing, in print-ready memory, a front-side page of the two-sided multiple page print job request that corresponds to one of the backside pages;
(e) printing the front-side page;
(f) releasing the front-side page from print-ready memory when no longer needed for printing, and
(g) repeating operations performed in paragraphs (b) through (f) until the multiple page print job request is complete.

23. A method, comprising:
receiving a multiple copy collated print job request;
storing data associated with printing copies of the multiple copy collated print job in volatile memory;
monitoring whether memory resources of the volatile memory are adequate to complete the multiple copy collated print job request; and
if it is determined that the memory resources of the volatile memory are inadequate to complete printing copies of the multiple copy collated print job, then releasing, without delay, objects associated with printing copies of the multiple collated print job.

23. The method as recited in claim 22, further comprising:
retaining data associated with printing an original copy of the multiple copy collated print job, if it is determined that the memory resources of the volatile memory are inadequate to complete printing copies of the multiple copy collated print job; and
printing the original copy of the multiple copy collated print job.

24. The method as recited in claim 22, further comprising declaring to a user that the print-ready memory is full.

25. A printing device, comprising: a memory system, configured to monitor memory resources and to immediately release, from memory, a majority of objects associated with printing non-original copies of a collated print job, if the memory system determines that the memory resources are inadequate to complete printing the non-original copies of the collated print job.

26. The printing device as recited in claim 25, wherein the memory resources are located in a volatile portion of memory for the printing device.

27. One or more computer-readable media having stored thereon computer executable instructions that, when executed by one or more processors, causes the one or more processors of a printing device to:
monitor memory resources of the printing device; and
release, before completing the original copy of the collated print job, all data associated with printing non-original copies of a collated print job, if the memory resources are determined to be inadequate to complete printing the non-original copies of the collated print job.

28. A printing device, comprising: a control system, configured to read one or more portions of data from a disk in print order rather than in logical page order for consumption by a print unit; and once the one or more portions of the data are no longer needed by the print unit, the control system is configured to release location(s) in which the data is stored.
